(19) United States
(12) Patent Application Publication
(10) Pub. No.: US 2014/0275544 A1
(43) Pub. Date: Sep. 18, 2014

(54) QUANTUM DOT-METAL OXIDE LINKERS

(71) Applicants: LOS ALAMOS NATIONAL SECURITY, LLC, Los Alamos, NM (US); SHARP CORPORATION, Osaka (JP)

(72) Inventors: Hunter McDaniel, Los Alamos, NM (US); Alexey Y. Koposov, Vancouver, WA (US); Anshu Pandey, Los Alamos, NM (US); Nobuhiro Fuke, Los Alamos, NM (US); Victor I. Klimov, Los Alamos, NM (US)

(21) Appl. No.: 13/797,768

(22) Filed: Mar. 12, 2013

(51) Int. Cl. H01B 1/02

(52) U.S. Cl. CPC H01B 1/026; H01B 1/02
USPC 546/2; 556/9; 556/31

(57) ABSTRACT

Embodiments of linkers for binding semiconductor quantum dots (QDs) to metal oxides are disclosed. The linkers have a general formula F1-A-(F2)_{z} wherein F1 is —COOH, —COO⁻, —PO₃H₂, —PO₃H⁻, —B(OH)₂, —BO₂H⁻, —SO₃H, —SO₃⁻, —NH₂, —SH, or —S⁻; A is aryl, heteroaryl, aliphatic, or heteroaliphatic; and z≧1 and each F2 independently is —PO₃H₂, —PO₃H⁻, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon. Methods of binding QDs to metal oxides with the disclosed linkers also are disclosed, as well as devices including the QD-functionalized metal oxides.

### ACKNOWLEDGMENT OF GOVERNMENT SUPPORT

This invention was made with government support under Contract No. DE-AC52-06NA25396 awarded by the U.S. Department of Energy. The government has certain rights in the invention.

### FIELD

This disclosure concerns linkers for attaching quantum dots to metal oxides to form quantum dot-functionalized metal oxides, methods of attaching quantum dots to metal oxides using the linkers, and devices comprising the quantum dot-functionalized metal oxides.

### PARTIES TO JOINT RESEARCH AGREEMENT

The research work described here was performed under a Cooperative Research and Development Agreement (CRADA) between Los Alamos National Laboratory (LANL) and Sharp Corporation, Japan, CRADA number LA11C10656.

### BACKGROUND

Quantum dots (QDs), such as semiconductor QDs, are of interest due to their strong absorption of light in the solar spectrum, simplicity and low-cost of synthesis, and high chemical stability. For use in devices, the QDs typically are attached to a substrate, such as a metal oxide. Quantum dot-functionalized substrates are useful in devices such as photoanodes, quantum dot-sensitized solar cells, light emitting diodes (LED), photosensors, nanostructured electronic arrays, thin film displays, field-effect transistors, and other optoelectronic devices.

### SUMMARY

Embodiments of quantum dot-functionalized metal oxides are disclosed. The quantum dot-functionalized metal oxide includes a quantum dot (QD) comprising a semiconductor, a I-II-IV-VI semiconductor, or a combination thereof, a metal oxide, and a linker binding the QD to the metal oxide. The linker has a first functional group (F1) capable of binding to the QD and one or more second functional groups (F2) capable of binding to the metal oxide. Embodiments of the linker have a general formula F1-A-(F2)_{z} wherein: F1 is —COOH, —COO⁻, —PO₃H₂, —B(OH)₂, —BO₂H⁻, —SO₃H, —SO₃⁻, —NH₂, —SH, or —S⁻; A is aryl, heteroaryl, aliphatic, or heteroaliphatic; and z≧1 and each F2 independently is —PO₃H₂, —PO₃H⁻, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon. In some embodiments, (F2)_{z} collectively is an oxysilane moiety and F1 is —NH₂, —SH, or —S⁻. In certain examples, A is phenyl or lower alkyl. In some embodiments, the QD further comprises a plurality of capping ligands selected from pyridine and RNH₂ where R is lower alkyl.

The metal oxide may comprise a transition metal. Exemplary metal oxides include TiO₂, SnO₂, ZrO₂, ZnO, WO₃, Nb₂O₅, Ta₂O₅, BaTiO₂, SrTiO₃, ZnTiO₃, CuTiO₃, or any combination thereof. In some embodiments, the metal oxide is mesoporous, e.g., mesoporous TiO₂, or a non-porous single crystal or polycrystalline film.

Exemplary linkers include, but are not limited to:

[chemical structure]

and combinations thereof.

In some embodiments, the QD includes a core comprising the semiconductor, the I-II-IV-VI semiconductor, or a combination thereof, and an outer cation-exchanged layer having a cation composition that differs from a cation composition of the core.

In certain embodiments, the composition comprises a plurality of quantum dots, which may have the same or different chemical compositions, and the composition further comprises a plurality of linkers having the general formula F1-A-(F2)_{z}, wherein the plurality of linkers includes at least a first linker and a second linker having a different formula than the first linker.

Embodiments of the disclosed QD-functionalized metal oxides are suitable for use in devices. Exemplary devices include a photoanode, a solar cell, a light-emitting diode, a photosensor, a nanostructured electronic array, a thin-film display, a battery, a fuel cell, an electrolytic cell, or a field-effect transistor.

Embodiments of a method for making a quantum dot-functionalized metal oxide include (i) exposing a metal oxide to a linker comprising a first functional group (F 1) capable of binding to a quantum dot and a plurality of second functional groups (F2) capable of binding to the metal oxide, wherein the linker has a general formula F1-A-(F2)_{z} wherein F1 is —COOH, —COO⁻, —PO₃H₂, —PO₃H⁻, —B(OH)₂, —BO₂H⁻, —SO₃H, —SO₃⁻, —NH₂, —SH, or —S⁻; A is aryl, heteroaryl, aliphatic, or heteroaliphatic; and z≧1 and each F2 independently is —PO₃H₂, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon, thereby producing a linker-functionalized metal oxide; and (ii) exposing the linker-functionalized metal oxide to a QD comprising a I-III-VI semiconductor, a I-II-IV-VI semiconductor, or a combination thereof, thereby producing a quantum dot-functionalized metal oxide. In some embodiments, (F2)_{z} collectively is an oxysilane moiety and F1 is —NH₂, —SH, or —S⁻.

Exposing the metal oxide to the linker may include exposing the metal oxide to a solution comprising the linker for a first period of time effective to bind the linker to the metal oxide. In some embodiments, the first period of time is 12-48 hours. Exemplary metal oxides include TiO₂, SnO₂, ZrO₂, ZnO, WO₃, Nb₂O₅, Ta₂O₅, BaTiO₂, SrTiO₃, ZnTiO₃, CuTiO₃, or a combination thereof.

Exposing the linker-functionalized metal oxide to the QD may include exposing the linker-functionalized metal oxide to a suspension comprising the QD for a second period of time effective to bind the QD to the linker. In certain embodiments, the second effective period of time is 24-48 hours.

The foregoing and other objects, features, and advantages of the invention will become more apparent from the following detailed description, which proceeds with reference to the accompanying figures.

### BRIEF DESCRIPTION OF THE DRAWINGS

FIG. 1 is a graph of absorbance versus photon energy for CuInS₂ quantum dot-functionalized TiO₂ films; various linkers were used to attach the quantum dots (QDs) to the film.

FIG. 2 is a graph of absorbance versus photon energy for CuInS₂-QDs linked to TiO₂ film with 4-aminobutyltriethoxysilane, showing that the QDs remained bound to the film after soaking for 12 days in octane.

FIG. 3 is graph of absorbance versus photon energy for CuInS₂ quantum dot-functionalized TiO₂ films; various linkers were used to attach the quantum dots (QDs) to the film.

FIG. 4 is a graph of absorbance versus photon energy for Cd-exchanged CuInS₂ quantum dot-functionalized TiO₂ films; various linkers were used to attach the cation-exchanged QDs (ceQDs) to the film.

FIG. 5 is a graph of absorbance versus photon energy for Cd-exchanged CuInS₂ quantum dot-functionalized TiO₂ films; various linkers were used to attach the ceQDs to the film.

FIG. 6 is a graph of absorbance versus photon energy for pyridine-capped, Cd-exchanged CuInS₂ quantum dot-functionalized TiO₂ films; various linkers were used to attach the recapped ceQDs to the film.

### DETAILED DESCRIPTION

Embodiments of linkers for attaching quantum dots (QDs) to metal oxides are disclosed. Methods of attaching a QD to a metal oxide with a linker to provide a QD-functionalized metal oxide, and devices including the QD-functionalized metal oxide are also disclosed. In some embodiments, a greater number of QDs are attached to a metal oxide when the QDs are conjugated to the metal oxide using the disclosed linkers.

### I. DEFINITIONS AND ABBREVIATIONS

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Unless otherwise indicated, non-numerical properties such as colloidal, continuous, crystalline, and so forth as used in the specification or claims are to be understood as being modified by the term “substantially,” meaning to a great extent or degree. Accordingly, unless otherwise indicated, implicitly or explicitly, the numerical parameters and/or non-numerical properties set forth are approximations that may depend on the desired properties sought, limits of detection under standard test conditions/methods, limitations of the processing method, and/or the nature of the parameter or property. When directly and explicitly distinguishing embodiments from discussed prior art, the embodiment numbers are not approximates unless the word “about” is recited.

Aliphatic: A substantially hydrocarbon-based compound, or a radical thereof (e.g., C₆H₁₃, for a hexane radical), including alkanes, alkenes, alkynes, including cyclic versions thereof, and further including straight- and branched-chain arrangements, and all stereo and position isomers as well. Unless expressly stated otherwise, an aliphatic group contains from one to twenty-five carbon atoms; for example, from one to fifteen, from one to ten, from one to six, or from one to four carbon atoms. The term lower aliphatic refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted.

Alkoxy: A radical (or substituent) having the structure —O—R, where R is alkyl. The term lower alkoxy means that the alkyl chain includes 1-10 carbons.

Alkyl refers to a hydrocarbon group having a saturated carbon chain. The chain may be unbranched, branched, or cyclic. The term lower alkyl means the chain includes 1-10 carbon atoms. Unless expressly referred to as an “unsubstituted alkyl,” an alkyl group may be substituted or unsubstituted.

Aryl or aromatic: An aryl, or aromatic, compound is an unsaturated, cyclic hydrocarbon having alternate single and double bonds. Unless expressly referred to as an “unsubstituted aryl,” an aryl group can be either unsubstituted or substituted.

Conjugating, joining, bonding, binding, or linking: Coupling a first unit to a second unit. This includes, but is not limited to, covalently bonding one molecule to another molecule or noncovalently bonding one molecule to another (e.g. electrostatically bonding).

Heteroaliphatic: An aliphatic compound or group having at least one heteroatom, i.e., one or more carbon atoms has been replaced with an atom having at least one lone pair of electrons, typically nitrogen, oxygen, phosphorus, silicon, or sulfur. Heteroaliphatic compounds or groups may be branched or unbranched, cyclic or acyclic. Unless expressly referred to as “unsubstituted heteroaliphatic,” a heteroaliphatic group may be substituted or unsubstituted.

Heteroaryl: An aryl compound or group having at least one heteroatom, i.e., one or more carbon atoms in the ring has been replaced with an atom having at least one lone pair of electrons, typically nitrogen, oxygen, phosphorus, silicon, or sulfur. Unless expressly referred to as an “unsubstituted heteroaryl,” a heteroaryl group may be substituted or unsubstituted.

Linker: A molecule or group of atoms positioned between two moieties. For example, a quantum dot bound to a substrate may include a linker between the quantum dot and the substrate. Typically, linkers are bifunctional, i.e., the linker includes a functional group at each end, wherein the functional groups are used to couple the linker to the two moieties. The two functional groups may be the same, i.e., a homobifunctional linker, or different, i.e., a heterobifunctional linker.

Oxysilane: A silicon-based functional group in which one or more alkoxy or hydroxyl groups are bound to silicon.

Quantum dot (QD): A nanoscale particle that exhibits size-dependent electronic and optical properties due to quantum confinement. The QDs disclosed herein generally have at least one dimension less than about 100 nanometers. The disclosed QDs may be colloidal QDs, i.e., QDs that may remain in suspension when dispersed in a liquid medium. Some QDs are made from a binary semiconductor material having a formula MX, where M is a metal and X typically is selected from sulfur, selenium, tellurium, nitrogen, phosphorus, arsenic, antimony or mixtures thereof. Exemplary binary QDs include CdS, CdSe, CdTe, GaAs, InAs, InN, InP, InSb, PbS, PbSe, PbTe, ZnS, ZnSe, and ZnTe. Other QDs are tertiary or ternary alloy QDs including, but not limited to, ZnSSe, ZnSeTe, ZnSTe, CdSSe, CdSeTe, ScSTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnHgSSe, ZnCdSeTe, ZnHgSeTe, CdHgSSe, CdHgSeTe, InGaAs, GaAlAs, InGaN, CuInS₂, Cu(In,Ga)Se₂, Cu(Zn,Sn)Se₂, Cu(Zn,Sn)S₂, CuIn(Se,S)₂, CuZn(Se,S)₂, CuSn(Se,S)₂, and Cu(Zn,Sn)(Se,S)₂ QDs. Embodiments of the disclosed QDs may be of a single material, or may comprise an inner core and an outer shell, e.g., a thin outer shell/layer formed by cation exchange. The QDs may further include a plurality of ligands bound to the quantum dot surface.

Substituted: A fundamental compound, such as an aryl, heteroaryl, aliphatic or heteroaliphatic compound, or a radical thereof, having coupled thereto a substituent (i.e., an atom or group of atoms that replaces a hydrogen atom on a parent chain or ring). Exemplary substituents include, but are not limited to, amine, amide, sulfonamide, halo, cyano, carboxy, hydroxyl, thiol, trifluoromethyl, alkyl, alkoxy, alkylthio, thioalkoxy, arylalkyl, heteroaryl, alkylamine, dialkylamine, or other functionality.

### II. QUANTUM DOTS

Embodiments of quantum dots (QDs) suitable for use with the disclosed linkers include quantum dots comprising a I-III-VI semiconductor, a I-II-IV-VI semiconductor, or a combination thereof. In some embodiments, the QDs may be alloyed with selenium to reduce the band gap and increase infrared absorption. Exemplary QDs comprise CuInS₂, CuZn_{y}Sn_{1-y}S₂, CuInSeₓS₂₋ₓ, CuZn_{y}Sn_{1-y}SeₓS₂₋ₓ, wherein 0≦x≦2 and 0<y<1, or a combination thereof. In certain embodiments, 1.3≦x≦1.7. In some examples, y=0.5. The disclosed QDs may be colloidal, i.e., of sufficiently small size to remain dispersed in a liquid suspension without a significant amount of settling. In certain embodiments, the QDs have an average diameter from 1-20 nm, such as from 2-10 nm.

In some embodiments, the QDs are cation-exchanged quantum dots (ceQDs) comprising a core and an outer layer, or shell, having a cation composition that differs from a cation composition of the core. The core may be a I-III-VI semiconductor, a I-II-IV-VI semiconductor, or a combination thereof as described above. Forming a wide band gap inorganic shell having a type I heterojunction with an emissive quantum dot core passivates the quantum dot surface and enhances phospholuminescence.

In some embodiments, a thin shell is deposited by shell growth, as is understood by a person of ordinary skill in the art of QD synthesis. Alternatively, a thin shell can be effectively produced by cation exchange, in which at least some of the outer cations are replaced to form an outer cation-exchanged layer. For example, when the core is CuInS₂ or CuInSeₓS₂₋ₓ, at least some of the outer Cu and/or In cations are replaced. Suitable metal cations, M, for exchange include, but are not limited to, Cd, Zn, Sn, Ag, Au, Hg, Cu, In, and combinations thereof.

In one embodiment, partial cation exchange of surface cations occurs. In another embodiment, substantially complete or complete cation exchange of surface cations occurs, thereby forming a substantially continuous or continuous outer cation-exchanged layer. As used herein with respect to complete cation exchange or a continuous outer cation-exchanged layer, “substantially” means at least 90%, such as at least 95%, at least 97%, or at least 99%. For example, when M is Cd or Zn, a surface having substantially only Cd or only Zn cations, respectively, may result.

In one embodiment, only surface cations are replaced during the cation exchange process, thereby forming a partial, continuous, or substantially continuous cation-exchanged outer monolayer (i.e., a one-atom thick layer of surface cations and anions surrounding the QD core). In another embodiment, cation exchange may penetrate deeper than the QD surface, and cations on, adjacent, and/or near the QD surface may be partially or completely exchanged.

A person of ordinary skill in the art understands that a QD population includes a distribution of QDs with varying sizes and/or compositions. In one non-limiting example, a QD population with an average size of 5 nm may have individual QDs ranging in size from 3-7 nm. Following partial cation-exchange, there may be variability in the percentage of QD cations that were exchanged. Thus, in one non-limiting example, although a CuInS₂ QD's outer surface may comprise 30% Cd cations after partial cation exchange with cadmium, individual QDs may have an outer surface comprising from 10-50% Cd cations. The variability in percentage of cation exchange may depend, in part, on the QD size variability. For example, under similar cation exchange conditions, a smaller QD may have a greater percentage of cations on its surface that are replaced during partial cation exchange than a larger QD.

Cation exchange is performed by combining the QDs with a solution comprising a cation for exchange. For example, a CuInS₂ QD may be combined with a solution comprising cadmium cations at a temperature and time sufficient for cation exchange to occur. Cd ions in solution will “exchange” with Cu and/or In cations on the QD surface. The extent of cation exchange may be controlled by varying the temperature and/or time of the cation exchange process, and/or by varying the concentration of the cation exchange solution relative to the concentration of quantum dots exposed to the cation exchange solution. Suitable temperatures for cation exchange may range from ambient to 200° C., and an effective period of time may range from 1 to 60 minutes. The extent of cation exchange generally increases as temperature and/or time are increased. In some embodiments, cation exchange does not change the quantum dot shape or size, in contrast to a shell that is deposited onto a quantum dot core.

QDs usually include surface-passivating (capping) ligands. Common ligands that are introduced during synthesis include tri-n-octylphosphine oxide, tri-n-octylphosphine, 1-dodecanethiol, oleylamine, or oleic acid/oleate. These large ligands with 8-24 carbon atoms may inhibit binding of the QDs to a substrate or to a linker. Thus, in some embodiments, the QDs are recapped with a smaller ligand, e.g., a ligand comprising 10 or fewer carbon atoms. In one embodiment, the QDs are recapped with pyridine. In another embodiment, the QDs are recapped with an amine, such as an aryl or lower alkyl amine. In certain embodiments, the ligands have a formula RNH₂ where R is lower alkyl, such as C2-C6 alkyl. Suitable amines include, but are not limited to, allylamine, propylamine, butylamine (e.g., n-butylamine, t-butylamine), pentylamine, hexylamine, heptylamine, octylamine, aniline, and benzylamine.

### III. METAL OXIDES

Embodiments of the linkers disclosed herein are suitable for attaching QDs to metal oxides. In some embodiments, the metal oxide comprises a transition metal oxide. Suitable metal oxides include, but are not limited to, TiO₂, SnO₂, ZrO₂, ZnO, WO₃, Nb₂O₅, NiO, Ta₂O₅, BaTiO₂, SrTiO₃, ZnTiO₃, CuTiO₃, and combinations thereof. In some embodiments, the metal oxide consists essentially of or consists of TiO₂, SnO₂, ZrO₂, ZnO, WO₃, Nb₂O₅, NiO, Ta₂O₅, BaTiO₂, SrTiO₃, ZnTiO₃, CuTiO₃, and combinations thereof. In certain embodiments, the metal oxide is TiO₂.

In some embodiments, the metal oxide is in the form of a thin film, a nanotube or nanorod. The metal oxide may be nanocrystalline, such as a polycrystalline or single-crystal metal oxide. In some examples, the metal oxide is a thin film with a thickness of 1 μm to 30 μm, 1 μm to 10 μm, 4 μm to 6 μm, 5 μm to 20 μm, 5 μm to 10 μm, or 10 μm to 15 μm.

In some embodiments, the metal oxide is a non-porous film. For example, the metal oxide may a dense, non-porous single crystal or polycrystalline film. In certain embodiments, the metal oxide is a mesoporous metal oxide, such as mesoporous TiO₂. In some examples, the mesoporous metal oxide has an average pore size of 20 nm to 50 nm, such as 20 nm to 40 nm.

The metal oxide may comprise a plurality of metal oxide particles. In some embodiments, the particles have an average diameter of 10 nm to 600 nm. In one example, the particles have an average diameter of 10 nm to 40 nm, such as 15 nm to 25 nm. In another example, the particles have an average diameter of 200 nm to 500 nm, e.g., 300 nm to 500 nm.

### IV. LINKERS

Embodiments of linkers suitable for binding a QD to a metal oxide are disclosed. The linkers include a first functional group (F1) capable of directly binding to the QD and one or more second functional groups (F2) capable of directly binding to the metal oxide. Some embodiments of the disclosed linkers have a general formula

F1-A-(F2)_{z}

wherein A is an aryl, heteroaryl, aliphatic, or heteroaliphatic moiety; F1 is —COOH, —COO⁻, —PO₃H₂, —PO₃H⁻, —B(OH)₂, —BO₂H⁻, —SO₃H, —SO₃⁻, —NH₂, —SH, or —S⁻; z≧1 and each F2 independently is —PO₃H₂, —PO₃H⁻, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon. Suitable oxysilane moieties include, but are not limited to, trimethoxysilane and triethoxysilane. When (F2)_{z} collectively is an oxysilane moiety, F1 may be —NH₂, —SH, or —S⁻. In some embodiments, A is phenyl or alkyl, such as lower alkyl. In certain examples, A is phenyl or C2-C5 alkyl.

In some embodiments, including a plurality of F2 groups or an oxysilane moiety comprising a plurality of lower alkoxy groups bound to silicon provides surprisingly superior binding of the linker, and hence QDs, to a metal oxide. In certain examples, including only a single F2 group on the linker unexpectedly reduced attachment of QDs to a metal oxide compared to attaching QDs in the absence of a linker (see, e.g., FIGS. 4-6, where terephthalic acid with only one F2 carboxyl group performed worse than a control with no linker).

Several exemplary linkers are shown below in Table 1.

TABLE 1

[chemical structure]

[chemical structure]

[chemical structure]

[chemical structure]

[chemical structure]

[chemical structure]

[chemical structure]

[chemical structure]

[chemical structure]

[chemical structure]

[chemical structure]

[chemical structure]

In certain embodiments, a combination of different linkers is utilized. A combination of linkers may be used, for instance, when the quantum dot includes a core and a partial outer shell or a partially cation-exchanged outer layer.

Embodiments of the disclosed linkers increase binding of QDs to a metal oxide as compared to direct binding (no linker) of the corresponding QD to the metal oxide. As the surface concentration of QDs bound to the metal oxide increases, the absorbance of the QD-functionalized metal oxide at a given photon energy increases. In some embodiments, the linker increases absorbance by at least 1.2×, at least 1.5×, or at least 2×.

The surface concentration of QDs bound to the metal oxide is also increased when QDs with large capping ligands are recapped with small ligands, such as pyridine or a short-chain amine (e.g., a C2-C6 amine) before binding the QDs to the metal oxide. Without wishing to be bound by any particular theory, replacement of larger capping ligands with smaller capping ligands (e.g., pyridine or C2-C6 amines) exposes more of the QD surface to the linker, thereby facilitating binding of the linker to the QD. In some embodiments, recapping the QDs and using an embodiment of the disclosed linkers increases binding of the QD to the metal oxide by at least 1.5×, such as 1.5× to 2× as compared to QDs that are not recapped before linking to the metal oxide.

Recapping the QDs and using an embodiment of the disclosed linkers improves QD binding to the metal oxide over either just recapping or just using a linker. In some embodiments, the combination of recapping QDs and using a linker to bind the recapped QDs to the metal oxide has a synergistic effect on the amount of QD binding and/or the density of bound QDs on the metal oxide surface. In other words, the amount of QD binding may be greater than expected based upon results obtained from just recapping or just using a linker. In certain examples, a combination of recapping (e.g., with pyridine) and linking QDs to a metal oxide with an embodiment of the disclosed linkers increased absorbance of the QD-functionalized metal oxide by at least 3×, such as 3× to 5×, compared to directly attaching a non-recapped QD to the metal oxide without a linker.

QD-functionalized metal oxides formed with embodiments of the disclosed linkers are stable when soaked in a liquid medium, such as a liquid medium suitable for forming a QD suspension. As used herein, the term “stable” means that the number of QDs bound to the metal oxide remains substantially the same. Stable binding can be determined by evaluating absorbance of the QD-functionalized metal oxide over time. The QD-functionalized metal oxide is removed from the liquid medium, rinsed with liquid medium, and the absorbance is measured. As the number of QDs bound to the metal oxide decreases, the absorbance decreases. In some embodiments, the QDs remain stably bound to the metal oxide for several days to several months when the QD-functionalized metal oxide is soaked in a liquid medium (e.g., octane) at ambient temperature. For example, the QDs may remain bound to the metal oxide for at least 1 day, at least 5 days, or at least 10 days when soaked in a liquid medium at ambient temperature. In one example, absorbance remained substantially the same after 12 days, indicating that the concentration of QDs bound to the metal oxide remained the same for at least 12 days. Stable binding is desirable, e.g., if the QD-functionalized metal oxide will be exposed to a liquid medium (e.g., a liquid suitable for forming a QD suspension or a liquid electrolyte) when used in a device.

### V. DEVICES

Quantum dot-functionalized metal oxides formed with embodiments of the disclosed linkers are suitable for use in devices including, but not limited to, photoanodes, quantum dot-sensitized solar cells, light emitting diodes (LED), photosensors, nanostructured electronic arrays, thin-film displays, field-effect transistors, batteries, fuel cells, electrolytic cells, and other optoelectronic devices. For example, a photoanode may include an electrically conducting substrate and a QD-functionalized metal oxide film on the electrically conducting substrate, wherein the QD-functionalized metal oxide comprises a plurality of QDs linked to the metal oxide by an embodiment of the disclosed linkers. A QD-sensitized solar cell may include the photoanode, a counter electrode, and a hole-extracting and hole-transporting material in contact with both the photoanode and the counter electrode. A QD-LED may comprise an anode, a QD-functionalized metal oxide electron-injecting layer, a hole-injecting layer, and a cathode.

### VI. METHODS OF LINKING QDS TO METAL OXIDE SUBSTRATES

A quantum dot, a metal oxide, and a linker are selected. The selected linker has a first functional group F1 suitable for binding the linker to the QD and one or more second functional groups F2 suitable binding the linker to the metal oxide. In some instances, a linker may be selected based, at least in part, on the cation composition of the QD's outer surface. In other instances, a linker may be selected based, at least in part, on the method used to prepare the QD and the resulting QD surface characteristics.

In some embodiments, the linker is first bound to the metal oxide to provide a linker-functionalized metal oxide. The linker may be dissolved in a solvent (e.g., acetonitrile, methanol, or another solvent suitable for dissolving the linker molecule) to provide a linker solution, and the metal oxide is exposed to the linker solution for an effective period of time. The metal oxide may be exposed to the linker solution by any suitable means, e.g., immersion in the solution, spraying the solution onto the metal oxide, etc. In some examples, the metal oxide is immersed in the linker solution for several hours to several days, such as from 12 hours to two days, or 12-36 hours. In certain embodiments, a metal oxide film is immersed in the linker solution for 24 hours. The linking procedure may be performed under an inert atmosphere, such as under an argon or nitrogen atmosphere. Unbound linker molecules can be removed by rinsing the linker-functionalized metal oxide, e.g., by rinsing with the solvent used to form the linker solution.

QDs then are bound to the linker-functionalized metal oxide. The QDs are dispersed in a suitable liquid medium to form a QD suspension, and the linker-functionalized metal oxide is exposed to the QD suspension for an effective period of time to produce a QD-functionalized metal oxide. In some embodiments, the liquid medium is non-polar solvent, such as an alkane or toluene. In certain examples, the liquid medium was octane. The effective period of time may range from several hours to several days, such as from 12 hours to two days, or 24-36 hours. The linker-functionalized metal oxide may be exposed to the QD suspension by any suitable means, e.g., immersion in the suspension, spraying the suspension onto the linker-functionalized metal oxide, etc. Unbound QDs can be removed by rinsing the QD-functionalized metal oxide, e.g., by rinsing with the liquid medium used to form the QD suspension.

In another embodiment, the linker is first attached to the QD. The linker is dissolved in a solvent to provide a linker solution. QDs are dispersed in a liquid medium to form a QD suspension. The linker solution and QD suspension are combined for a first effective period of time, such as several hours to several days, e.g., 12-48 hours. The solvent and liquid medium are selected to be compatible with one another, as well as with the linker and the QDs. In some examples, the solvent and liquid medium have the same chemical composition. After the first effective period of time, the linker-functionalized QDs are attached to a metal oxide by exposing the metal oxide to the QD-linker suspension for a second effective period of time (e.g., several hours to several days, such as 12-48 hours) to form the QD-functionalized metal oxide. Unbound linkers, QDs, and QD-linkers are then removed by rinsing the metal oxide.

### VII. EXAMPLES

### General Procedures

Metal Oxide Preparation:

Mesoporous TiO₂ on a glass substrate was obtained from Sharp Corporation. The TiO₂ particles had an average diameter of 23 nm, and the TiO₂ film had an average pore size of 30 nm. The film had an average thickness of approximately 8 μm. The mesoporous TiO₂ film can be prepared by screen-printing a TiO₂ paste, which is subsequently heated to 500° C. in air to evaporate solvent, burn out organics in the paste, and sinter the TiO₂ particles.

Cation Exchange:

For cation exchange with Cd, a stock solution of 0.5 M cadmium oleate was prepared with 3:1 oleic acid:Cd dissolved in octadecene. A 4 mL aliquot of the cleaned QDs in octane solution (˜50 mg/mL) was added to 4 mL of 0.5 M cadmium oleate solution and set to 50-150° C. depending on the desired degree of cation exchange. Cation exchange was performed for 10 minutes unless otherwise noted.

QD Recapping:

QDs were cleaned twice as follows. QDs (0.5 g) were dissolved in chloroform, and acetone was added to precipitate the QDs. The QDs were centrifuged, and redissolved in chloroform. Methanol was added to precipitate the QDs. Precipitated QDs were collected by centrifugation. The QDs were redissolved in a minimal amount of chloroform, and then were recapped by adding the QD solution to 10 ml anhydrous pyridine or tert-butylamine. The solution was stirred overnight at 60° C. The recapped QDs then were precipitated by adding methanol, and the mixture was then centrifuged. The capped QDs were dissolved in pyridine+octane, toluene, or octane, diluted to an absorbance of about 0.2 (approximately 0.01 g/mL) at the 1S absorption peak (typically 850 nm), and used to prepare QD-functionalized TiO₂ films.

QD-Functionalized Metal Oxide Preparation:

A selected linker (i.e., a linker as disclosed in Table 1 or Examples 1-3) was dissolved in a suitable solvent. Unless otherwise indicated, the solvent was acetonitrile. The TiO₂ film was then soaked in the linker solution for one day in a glove box under an argon atmosphere. The TiO₂ film subsequently was rinsed with acetonitrile to remove unbound linker molecules. The linker-functionalized TiO₂ film was then soaked in a suspension of QDs in octane for 1-2 days to form a QD-functionalized TiO₂ film. The QD-functionalized TiO₂ film was rinsed with octane to remove unbound QDs.

Spectroscopy:

UV-vis absorption spectra were obtained with an Agilent 8453 photodiode array spectrometer.

### Example 1

### Linkers for Attaching CuInS₂ QDs to TiO₂

CuInS₂ QDs were attached to TiO₂ as described above in General Procedures. To evaluate which functional group (F1) is most effective for attachment to the QD, the following linkers were used: 4-aminobutyltriethoxysilane (ABTES), p-aminophenyltrimethoxysilane (APTMS-2), 3-mercaptopropyltrimethoxysilane (MPTMS), or benzene-1,3,5-tricarboxylic acid (BTCA). As a control, no linker was used.

The results are shown in FIG. 1. At a given photon energy, the absorbance increases as the surface concentration (i.e., number of QDs per unit area) of QDs bound to the TiO₂ surface increases. As shown in FIG. 1, linkers including an amino group as F1 (ABTES and APTMS-2) provided the best results, whereas MPTMS (F1=thiol) performed worse than the control with no linker. BTCA performed only slightly better than the control. These results are exemplary, and may differ when using QDs prepared by another method and/or under different synthesis conditions.

The QD functionalized films remain stable over time. A QD-functionalized film prepared with the ABTES linker was soaked in octane for 12 days. As shown in FIG. 2, the absorbance was substantially the same after 12 days, indicating that the QDs remained bound to the TiO₂. Absorbance spectra obtained at 1 day, 2 days, 3 days, 4 days, 5 days, and 12 days over a wavelength range of 400-700 nm showed virtually no change over time.

Additional linkers were evaluated to determine the effect of having one or more F2 groups: β-alanine (BAL, 3-aminopropionic acid), 5-aminovaleric acid (AV, 5-aminopentanoic acid), 4-aminobutanoic acid (AB), 6-aminohexanoic acid (AH), 5-aminoisophthalic acid (AI), 3,5-diaminobenzoic acid (DBen), 4-aminobenzoic acid (ABen), and 3-aminopropyltrimethoxysilane (APTMS-1). The linker solutions were prepared in either acetonitrile (AcN) or methanol (Me).

Absorbance spectra of the QD-functionalized TiO₂ films are shown in FIG. 3. At a given wavelength, the absorbance increases as the concentration of QDs bound to the TiO₂ surface increases. The best results were obtained with AI and APTMS-1. Thus, the linker was more effective when it included two or more F2 functional groups. Both oxysilane (e.g., trialkoxysilane) and carboxyl groups were demonstrated to effectively bind the QDs to the TiO₂.

### Example 2

### Linkers for Attaching Cd-Exchanged CuInS₂ QDs to TiO₂

Cation-exchanged quantum dots (ceQDs) were prepared as described in General Procedures. The ceQDs had a CuInS₂ core and an outer cation-exchanged layer comprising Cd. Cation exchange was performed at 150° C., resulting in substantially complete cation exchange and producing an outer layer of CdS.

The ceQDs were attached to TiO₂ as described above in General Procedures. To determine which functional group(s) (F1) are most effective for attachment to the ceQD, the following linkers were used: 4-aminobutyltriethoxysilane (ABTES), 3-aminopropyltrimethoxysilane (APTMS-1), 3-mercaptopropyltrimethoxysilane (MPTMS), benzene-1,3,5-tricarboxylic acid (BTCA), and terephthalic acid (TPA, benzene-1,4-dicarboxylic acid).

The most effective binding was obtained when the linker was BTCA or MPTMS (FIG. 4). Linkers containing an amino group were ineffective for binding the ceQDs to the TiO₂ film, and performed worse than the control with no linker. TPA, which has only one carboxyl group available for binding to TiO₂, also performed worse than the control.

FIG. 5 shows absorbance spectra of ceQDs bound to TiO₂ with BTCA, MPTMS, TPA, or no linker. Again, BTCA and MPTMS provided superior results.

### Example 3

### Attaching Recapped ceQDs to TiO₂

Cd-exchanged CuInS₂ QDs were prepared as described in Example 2. The ceQDs subsequently were recapped with pyridine, and evaluated to determine whether smaller capping ligands facilitate binding the ceQDs to TiO₂. BTCA, MPTMS, and TPA linkers were evaluated.

The results are shown in FIG. 6. BTCA and MPTMS provided superior results compared to the control and TPA.

A comparison of FIG. 4 with FIG. 6 shows that recapping the ceQDs with a smaller ligand, such as pyridine, enhanced the quantum dot binding. For example, at 2.5 eV, ceQDs linked with BTCA to TiO₂ produced a film having an absorbance of ˜0.2 (FIG. 4). When the ceQDs were recapped with pyridine and linked with BTCA to TiO₂, the film had an absorbance of ˜0.32 (FIG. 6). When the linker was MPTMS, the absorbance at 2.5 eV increased from ˜0.17 (FIG. 4) to ˜0.3 (FIG. 6) after the ceQDs were recapped with pyridine.

The best results were obtained when the ceQD was recapped with pyridine and a linker was used to bind the recapped ceQD to the TiO₂. Cd-exchanged CuInS₂ QDs bound to TiO₂ with no linker produced an absorbance of ˜0.7 at a photon energy of 2.5 eV (FIG. 4), whereas pyridine-capped, Cd-exchanged CuInS₂ QDs linked to TiO₂ with BTCA had an absorbance of ˜0.32 at 2.5 eV (FIG. 6).

Without wishing to be bound by any particular theory, replacement of large capping ligands with smaller capping ligands (e.g., pyridine or C2-C6 amines) exposes more of the QD surface to the linker, thereby facilitating binding of the linker to the QD.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A composition, comprising:
a quantum dot-functionalized metal oxide, comprising
a quantum dot comprising a I-III-VI semiconductor, a I-II-IV-VI semiconductor, or a combination thereof;
a metal oxide; and
a linker binding the quantum dot to the metal oxide, wherein the linker comprises a first functional group (F1) capable of binding to the quantum dot and a plurality of second functional groups (F2) capable of binding to the metal oxide, wherein the linker has a general formula F1-A-(F2)_{z} wherein:
F1 is —COOH, —COO⁻, —PO₃H₂, —PO₃H⁻, —B(OH)₂, —BO₂H⁻, —SO₃H, —SO₃⁻, —NH₂, —SH, or —S⁻,
A is aryl, heteroaryl, aliphatic, or heteroaliphatic, and
z≧1 and each F2 independently is —PO₃H₂, —PO₃H⁻, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon.

2. The composition of claim 1, wherein (F2)_{z} collectively is an oxysilane moiety and F1 is —NH₂, —SH, or —S⁻.

3. The composition of claim 1, wherein A is phenyl or lower alkyl.

4. The composition of claim 1, wherein the quantum dot further comprises a plurality of capping ligands selected from pyridine and RNH₂ where R is lower alkyl.

5. The composition of claim 1, wherein the metal oxide comprises a transition metal oxide.

6. The composition of claim 1, wherein the metal oxide is TiO₂, SnO₂, ZrO₂, ZnO, WO₃, Nb₂O₅, Ta₂O₅, BaTiO₂, SrTiO₃, ZnTiO₃, CuTiO₃, or a combination thereof.

7. The composition of claim 1, wherein the metal oxide is mesoporous.

8. The composition of claim 1, wherein the metal oxide is a non-porous single crystal or polycrystalline film.

9. The composition of claim 1, wherein the linker is [chemical structure]
or a combination thereof.

10. The composition of claim 1, wherein the quantum dot comprises:
a core comprising the I-III-VI semiconductor, the I-II-IV-VI semiconductor, or a combination thereof; and
an outer layer having a cation composition that differs from a cation composition of the core.

11. A device comprising the composition of claim 1, wherein the device is a photoanode, a solar cell, a light-emitting diode, a photosensor, a nanostructured electronic array, a thin-film display, a battery, a fuel cell, an electrolytic cell, or a field-effect transistor.

12. A method, comprising:
exposing a metal oxide to a linker comprising a first functional group (F1) capable of binding to a quantum dot and a plurality of second functional groups (F2) capable of binding to the metal oxide, wherein the linker has a general formula F1-A-(F2)_{z} wherein:
F1 is —COOH, —COO⁻, —PO₃H₂, —PO₃H⁻, —B(OH)₂, —BO₂H⁻, —SO₃H, —SO₃⁻, —NH₂, —SH, or —S⁻,
A is aryl, heteroaryl, aliphatic, or heteroaliphatic, and
z≧1 and each F2 independently is —PO₃H₂, —PO₃H⁻, —B(OH)₂, —BO₂H⁻, —SO₃H, —SO₃⁻, or z≧2 and each F2 independently is —COOH, —COO⁻, —PO₃H₂, —PO₃H⁻, —B(OH)₂, —BO₂H⁻, —SO₃H, or —SO₃⁻, or z≧2 and (F2)_{z} collectively is an oxysilane moiety comprising z lower alkoxy groups bound to silicon, thereby producing a linker-functionalized metal oxide; and
exposing the linker-functionalized metal oxide to a quantum dot comprising a I-III-VI semiconductor, a I-II-IV-VI semiconductor, or a combination thereof, thereby producing a quantum dot-functionalized metal oxide.

13. The method of claim 12, wherein (F2)_{z} collectively is an oxysilane moiety and F1 is —NH₂, —SH, or —S⁻.

14. The method of claim 12, wherein exposing the metal oxide to the linker comprises exposing the metal oxide to a solution comprising the linker for a first period of time effective to bind the linker to the metal oxide.

15. The method of claim 14, wherein the first period of time is 12-48 hours.

16. The method of claim 12, wherein the metal oxide is TiO₂, SnO₂, ZrO₂, ZnO, WO₃, Nb₂O₅, Ta₂O₅, BaTiO₂, SrTiO₃, ZnTiO₃, CuTiO₃, or a combination thereof.

17. The method of claim 12, wherein exposing the linker-functionalized metal oxide to the quantum dot comprises exposing the linker-functionalized metal oxide to a suspension comprising the quantum dot for a second period of time effective to bind the quantum dot to the linker.

18. The method of claim 17, wherein the second effective period of time is 24-48 hours.

19. The method of claim 12, wherein the quantum dot comprises:
a core comprising the I-III-VI semiconductor, the I-II-IV-VI semiconductor, or a combination thereof; and
an outer layer having a cation composition that differs from a cation composition of the core.

20. The method of claim 12, wherein the linker is [chemical structure]
or a combination thereof.
